(19) United States
(12) Patent Application Publication
(10) Pub. No.: US 2019/0369917 A1
(43) Pub. Date: Dec. 5, 2019

(54) MEMORY APPARATUS AND COMMAND REORDERING METHOD

(71) Applicant: Shanghai Zhaoxin Semiconductor Co., Ltd., Shanghai (CN)

(72) Inventor: Jie Jin, Shanghai (CN)

(73) Assignee: Shanghai Zhaoxin Semiconductor Co., Ltd., Shanghai (CN)

(21) Appl. No.: 16/109,772

(22) Filed: Aug. 23, 2018

(30) Foreign Application Priority Data
May 29, 2018 (CN) 201810534220.0

(51) Int. Cl. G06F 3/06

(52) U.S. Cl. CPC G06F 3/0659; G06F 3/0673; G06F 3/0604

(57) ABSTRACT

A memory apparatus including a controller and at least one memory is provided. The controller provides a plurality of access commands and performs a command reordering method for the access commands. The command reordering method includes a rank level step, selecting at least one command having a rank address of a previous scheduling command from the access commands as at least one first candidate command; a bank level step, selecting at least one command having a different bank address compared to the previous scheduling command from the at least one first candidate command as at least one second candidate command; and selecting one command from the at least one second candidate command as a current scheduling command.

### CROSS-REFERENCE TO RELATED APPLICATION

This application claims the priority benefit of China application serial no. 201810534220.0, filed on May 29, 2018. The entirety of the above-mentioned patent application is hereby incorporated by reference herein and made a part of this specification.

### BACKGROUND OF THE INVENTION

### 1. Field of the Invention

The invention relates to an electronic apparatus, and more particularly, to a memory apparatus and a command reordering method thereof.

### 2. Description of Related Art

In the conventional technology of Double Data Rate Fourth Generation Synchronous Dynamic Random Access Memory (DDR4 SDRAM), a command scheduling mechanism includes a non-reordering mechanism. The non-reordering approach directly takes out a command at a first position of a command queue so the command can then be converted into the corresponding command in DDR4 format and transmitted to the memory. However, a DDR4 parallel computing capability is not fully utilized between banks of memory with the conventional non-reordering mechanism. Other than that, a command order is not optimized inside the bank to reduce page conflict. Consequently, bandwidth utilization of DDR4 is lower.

### SUMMARY OF THE INVENTION

The disclosure provides a memory apparatus and a command reordering method for improving memory bandwidth utilization.

An embodiment of the invention provides a memory apparatus. The memory apparatus includes a controller and at least one memory. The controller is coupled to the memory. The controller provides a plurality of access commands and performs a command reordering method for the access commands. The command reordering method includes: a rank level step, selecting at least one command having a rank address of a previous scheduling command from the access commands as a first candidate command; a bank level step, selecting at least one command having a different bank address compared to the previous scheduling command from the at least one first candidate command as a second candidate command; and selecting one command from the at least one second candidate command as a current scheduling command.

An embodiment of the invention provides a command reordering method adapted to a memory apparatus. The memory apparatus includes a controller and at least one memory. The command reordering method includes a rank level step, selecting at least one command having a rank address of a previous scheduling command from a plurality of access commands provided by the controller as a first candidate command; a bank level step, selecting at least one command having a different bank address compared to the previous scheduling command from the at least one first candidate command as a second candidate command; and selecting one command from the at least one second candidate command as a current scheduling command.

Based on the above, the memory apparatus and the command reordering method are capable of optimizing memory bandwidth performance. The commands are reordered based on the rank level and bank level so as to reduce the probability of page conflict in the banks and effectively improve memory bandwidth utilization.

To make the above features and advantages of the invention more comprehensible, several embodiments accompanied with drawings are described in detail as follows.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a circuit block diagram illustrating a memory apparatus according to an embodiment of the invention.

FIG. 2 is a flowchart illustrating a command reordering method according to an embodiment of the invention.

FIG. 3 is a circuit block diagram illustrating the controller 120 depicted in FIG. 1 according to an embodiment of the invention.

FIG. 4 is a schematic diagram illustrating a cluster structure of a plurality of bank queues in a write scheduling queue (a write command queue set) depicted in FIG. 3 according to an embodiment of the invention.

FIG. 5 is a flowchart illustrating how access commands are pushed into the corresponding bank queue according to an embodiment of the invention.

FIG. 6 is a flowchart illustrating the command reordering method according to another embodiment of the invention.

FIG. 7 illustrates a flowchart for reordering read scheduling queues in rank level, bank group level and bank level according to an embodiment of the invention.

FIG. 8 illustrates a flowchart for reordering write scheduling queues in rank level, bank group level and bank level according to an embodiment of the invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

The term “coupled (or connected)” used in this specification (including claims) may refer to any direct or indirect connection means. For example, “a first device is coupled (connected) to a second device” should be interpreted as “the first device is directly connected to the second device” or “the first device is indirectly connected to the second device through other devices or connection means”. Moreover, elements/components/steps with same reference numerals represent same or similar parts in the drawings and embodiments. Elements/components/steps with the same reference numerals or names in different embodiments may be cross-referenced.

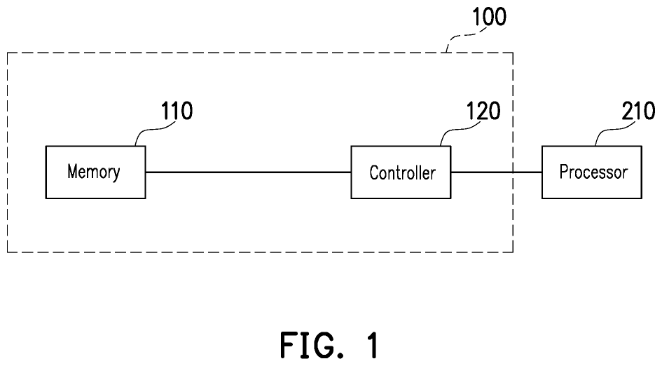

FIG. 1 is a circuit block diagram illustrating a memory apparatus according to an embodiment of the invention. With reference to FIG. 1, a memory apparatus 100 may include a memory 110 and a controller 120. The memory 110 is coupled to the controller 120. In this embodiment, a processor 210 (or a host) may send an access request to the controller 120 in order to access the memory 110. The processor 210 may be a central processing unit (CPU), a programmable microprocessor, a digital signal processor (DSP), a programmable controller, an application specific integrated circuit (ASIC) or other similar devices or a combination of above-mentioned devices.

Based on the received request, the controller 120 may provide/generate a plurality of access commands for the memory 110, and said access commands may be read commands or write commands. That is to say, the controller 120 may perform an access operation on the memory 110 according to the access request of the processor 210. Before outputting the access commands, the controller 120 may perform a command reordering method for a plurality of access commands such that the reordered access commands may be submitted to the memory 110.

According to different design requirements, the memory 110 may a fixed memory or a portable memory in any form. The memory 110 may include a random access memory (RAM), a read-only memory (ROM), a flash memory or other similar devices or a combination of the above-mentioned devices. The controller 120 may be a central processing unit (CPU) or a programmable microprocessor, a digital signal processor (DSP), a programmable controller, an application specific integrated circuit (ASIC) or other similar devices or a combination of above-mentioned devices.

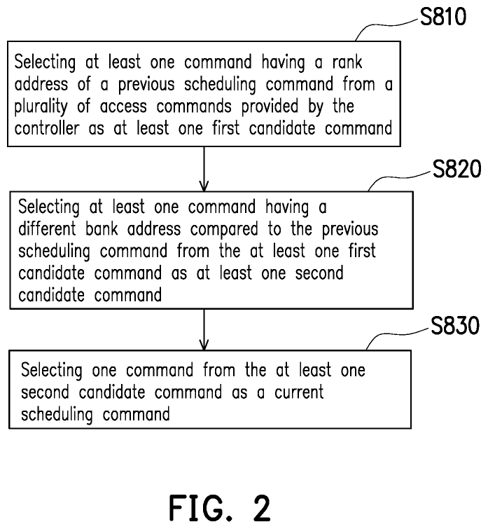

FIG. 2 is a flowchart illustrating a command reordering method according to an embodiment of the invention. In step S810 (a rank level step), the controller 120 selects at least one command having a rank address of a previous scheduling command from a plurality of access commands provided by the controller 120 as at least one first candidate command. “The previous scheduling command” refers to the access command that is previous executed. While the controller 120 is providing a plurality of access commands, an access efficiency of the memory 110 would be reduced if the rank addresses are frequently changed. When a plurality of consecutive access commands all have the same rank address, the memory 110 may be accessed more efficiently. By executing step S810 (the rank level step), the command(s) having the same rank address as the previous scheduling request may be selected from the access commands stored in a queue. Accordingly, step S810 (the rank level step) may allow a plurality of access commands having the same rank address to be grouped together and executed in sequence so the memory 110 may be accessed more efficiently. When the command having the same rank address of “the previous scheduling command” does not exist in the access commands, the controller 120 may select command(s) having a next rank address from the access commands as the first candidate command. Here, the next rank address is different from the rank address of “the previous scheduling commands”.

Next, in step S820 (a bank level step), the controller 120 may select at least one command having a different bank address compared to the previous scheduling command from the first candidate command as at least one second candidate command. In step S830, the controller 120 may select one command from the at least one second candidate command as a current scheduling command (a current executing command). When there are two consecutive access commands having the same bank address, these two access commands are often two commands that conflict with each other. When there appear to be two consecutive access commands in conflict, the controller 120 will send an assistive command (e.g., a pre-charge command, an active command and/or other assistive commands) to eliminate the conflicting situation for the two access commands. Obviously, executing the additional assistive command will take extra time and thus reduce the access efficiency of the memory 110. If the two consecutive access commands have different bank addresses, the memory 110 may be accessed more efficiently. Accordingly, step S820 (the bank level step) allows the previous scheduling command and the current scheduling (executing) command to include different bank addresses so the memory 110 may be accessed more efficiently.

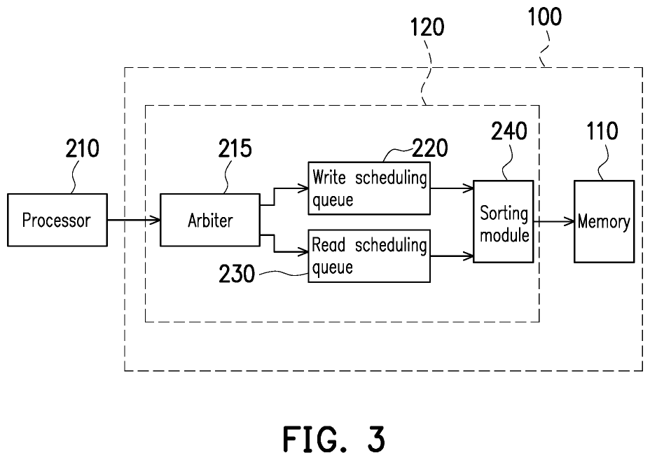

FIG. 3 is a circuit block diagram illustrating the controller 120 depicted in FIG. 1 according to an embodiment of the invention. With reference to FIG. 3, the controller 120 may include an arbiter 215, a write scheduling queue 220, a read scheduling queue 230 and a sorting module 240. In some embodiments, the arbiter 215 may include a command decoder (not illustrated). In some other embodiments, the command decoder (not illustrated) may be disposed outside the arbiter 215 as a previous stage device of the arbiter 215. The command decoder (not illustrated) is configured to receive a plurality of access requests provided by the processor 210 and convert/decode the access request into the corresponding access command. The arbiter 215 determines whether the access command is the write command or the read command, and pushes the write command and the read command into the write scheduling queue 220 and the read scheduling queue 230 respectively for command scheduling.

The write scheduling queue 220 and the read scheduling queue 230 are virtual queues. In fact, each bank address has a physical bank queue, and the write scheduling queue 220 is composed of all the bank queues together for storing the write commands. Therefore, the write scheduling queue 220 is also known as a write command queue set. By analogy, the read scheduling queue 230 may also be composed of a plurality of bank queues together for storing the read commands. Therefore, the read scheduling queue 230 is also known as a read command queue set.

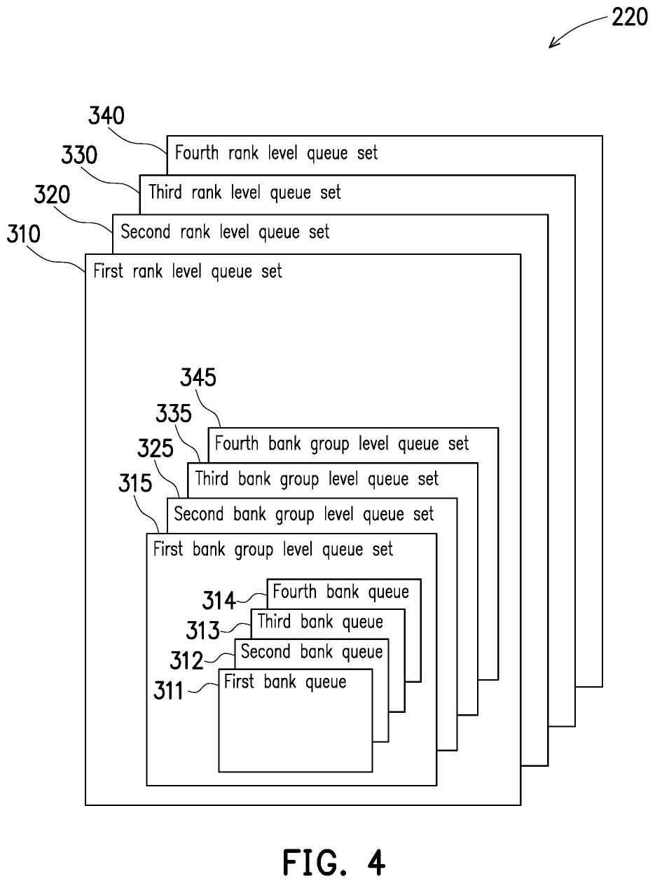

FIG. 4 is a schematic diagram illustrating a cluster structure of a plurality of bank queues in the write scheduling queue 220 (the write command queue set) depicted in FIG.

3 according to an embodiment of the invention. A cluster structure of a plurality of bank queues in the read scheduling queue 230 (the read command queue set) depicted in FIG. 3 may be analogized with reference to related description for the write scheduling queue 220 depicted in FIG. 4 without repeated description further provided. With reference to FIG. 4, the write scheduling queue 220 (the write command queue set) includes a plurality of rank level queue sets, such as a first rank level queue set 310, a second rank level queue set 320, a third rank level queue set 330 and a fourth rank level queue set 340 shown in FIG. 4.

Each of the rank level queue sets includes a plurality of bank group level queue sets. For instance, the first rank level queue set 310 includes a first bank group level queue set 315, a second bank group level queue set 325, a third bank group level queue set 335 and a fourth bank group level queue set 345. The other rank level queue sets may be analogized with reference to related description for the first rank level queue set 310 without repeated description further provided.

Each of the bank group level queue sets includes a plurality of bank queues. For instance, the first bank group level queue set 315 includes a first bank queue 311, a second bank queue 312, a third bank queue 313 and a fourth bank queue 314. The other bank group level queue sets may be analogized with reference to related description for the first bank group level queue set 315 without repeated description further provided.

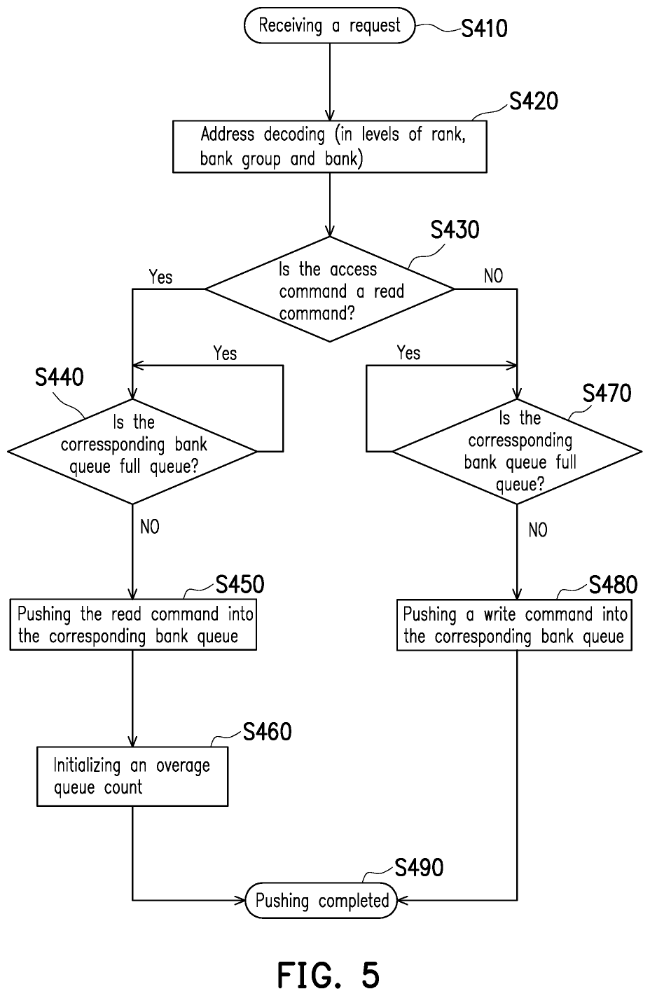

FIG. 5 is a flowchart illustrating how access commands are pushed into the corresponding bank queue according to an embodiment of the invention. Referring to FIG. 3 and FIG. 5 together, in step S410, the controller 120 in the memory apparatus 100 receives a request from the processor 210. Next, in step S420, the controller 120 decodes the request of the processor 210 to generate decoded addresses (physical addresses) and the corresponding access commands. In step S430, the controller 120 determines whether the access command is the read command. If the access command is the read command, the controller 120 executes step S440. In step S440, the controller 120 determines whether the corresponding bank queue in the read scheduling queue 230 (the read command queue set) is full queue. If the corresponding bank queue is full, the controller 120 repeats step S440 again to wait for free storage space of the corresponding bank queue. If the corresponding bank queue is not full, the controller 120 pushes this read command into the corresponding bank queue in the read scheduling queue 230 (the read command queue set) in step S450. Then, the controller 120 initializes an overage queue count corresponding to this read command in step S460. By executing step S460, the overage queue count corresponding to the read command may be set to an initial value, and a size of this initial value may be determined based on design requirements. Wherein, the overage queue count is configured to determine a delayed condition of this read command so Quality of Service (QoS) can be ensured. Step S490 indicates that one pushing action is completed for the request of the processor 210.

If it is determined that the access command is not the read command (i.e., the access command is the write command) in step S430, the controller 120 executes step S470. In step S470, the controller 120 determines whether the corresponding bank queue in the write scheduling queue 220 (the write command queue set) is full queue. If the corresponding bank queue is full, the controller 120 repeats step S470 again to wait for storage space of the corresponding bank queue. If the corresponding bank queue is not full, the controller 120 pushes this write command into the corresponding bank queue in the write scheduling queue 220 (the write command queue set) in step S480. Next, in step S490, the controller 120 completes one pushing action for the request of the processor 210. In this way, the process above can push the access command into the queues for reordering such that the sorting module 240 may perform the command reordering method.

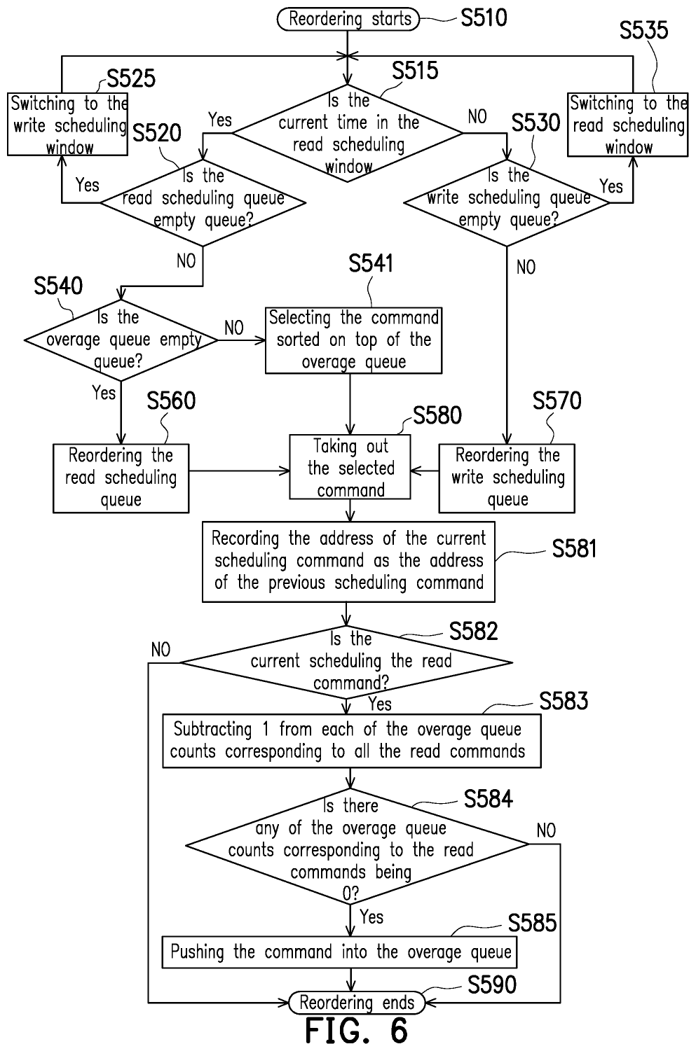

FIG. 6 is a flowchart illustrating the command reordering method according to another embodiment of the invention. With reference to FIG. 3, FIG. 4 and FIG. 6, in step S510, the sorting module 240 of the controller 120 may start performing one reordering, that is, to perform one command scheduling. In step S515, the sorting module 240 may determine whether a current time is in a read scheduling window. When the current time is in the read scheduling window, the sorting module 240 executes step S520 to obtain a first checking result by checking whether a read command queue set (the read scheduling queue 230) is empty and determine whether to enter the write scheduling windows by ending the read scheduling window according to the first checking result. When the current time is not in the read scheduling window (i.e., the current time is in the write scheduling window), the sorting module 240 executes step S530 to obtain a second checking result by checking whether the write command queue set (the write scheduling queue 220) is empty and determine whether to enter the read scheduling window by ending the write scheduling window according to the second checking result.

Specifically, in step S520, the sorting module 240 may determine whether the read scheduling queue 230 (the read command queue set) is empty queue. If the read scheduling queue 230 is empty queue, the sorting module 240 executes step S525, that is, the sorting module 240 ends the read scheduling window, switches to the write scheduling window and then executes step S515. If it is determined that the read scheduling queue 230 is not empty queue in step S520, the sorting module 240 executes step S540 (which will be described later). In step S530, the sorting module 240 may determine whether the write scheduling queue 220 (the write command queue set) is empty queue. If the write scheduling queue 220 is empty queue, the sorting module 240 executes step S535, that is, the sorting module 240 ends the write scheduling window, switches to the read scheduling window and executes step S515 again. If it is determined that the write scheduling queue 220 is not empty queue in step S530, the sorting module 240 executes step S570 (which will be described later).

During the process of executing the access commands, if the controller 120 frequently switches between the write command and the read command, the controller 120 and the memory 110 need to spend extra time for switching so that the access efficiency of the memory 110 is reduced. When all the consecutive access commands are the write commands (or the read commands), the memory 110 may be accessed more efficiently. By executing steps S515 to S535, the read command stored by the read scheduling queue 230 (the read command queue set) may be obtained (executed) in one time window, and the write command stored by the write scheduling queue 220 (the write command queue set) may be obtained (executed) in another time window. Accordingly, step S515 to S535 allows the controller 120 to continuously perform reading (or continuously perform write) whenever possible to reduce the switching between the read command and the write command so the memory 110 may be accessed more efficiently.

When the current time is in the read scheduling window, the sorting module 240 may execute step S540 to check whether an overage queue is empty queue. If the overage queue is empty, the sorting module 240 executes step S560 to reorder the read commands (the access commands) stored by the read scheduling queue 230 (the read command queue set). The implementation details of step S560 may be analogized with reference to the related description of FIG. 2, which is not repeated hereinafter. After one read command is selected from the read scheduling queue 230 (the read command queue set) in step S560, the sorting module 240 may execute step S580 to use the selected read command as the current scheduling command (the current executing command) and take out the current scheduling command from the read scheduling queue 230.

If it is determined that the overage queue is not empty in step S540, the sorting module 240 may select the read command sorted on top of the overage queue as the current scheduling command (the current executing command). Next, in step S580, the sorting module 240 may take out the selected access command (which is the read command at the time).

When the current time is in the write scheduling window, the sorting module 240 may execute step S530 to check whether the write scheduling queue 220 (the write command queue set) is empty queue. If it is determined that the write scheduling queue 220 is not empty queue in step S530, the sorting module 240 executes step S570 to reorder the write commands (the access commands) stored in the write scheduling queue 220 (the write command queue set). The implementation details of step S570 may be analogized with reference to the related description of FIG. 2, which is not repeated hereinafter. After one write command is selected from the write scheduling queue 220 (the write command queue set) in step S570, the sorting module 240 may execute step S580 to use the selected write command as the current scheduling command (the current executing command) and take out the current scheduling command from the write scheduling queue 220.

After step S580 is completed, the sorting module 240 may execute step S581. In step S581, the sorting module 240 may record an address (e.g., the rank address, a bank group address and/or the bank address) of the current scheduling command (the current executing command) as an address of “the previous scheduling command”. Next, in step S582, the sorting module 240 may determine whether the current scheduling command is the read command. If the current scheduling command is the read command, the sorting module 240 may execute step S583. If the current scheduling command is not the read command, the sorting module 240 may execute step S590, i.e., to complete one command scheduling.

In step S583, the sorting module 240 may subtract 1 from each of the overage queue counts corresponding to all the read commands. Next, in step S584, the sorting module 240 may determine whether any of the overage queue counts corresponding to the read commands is 0. If one (or more) of the overage queue counts corresponding to the read commands is 0, the sorting module 240 may execute step S585. In step S585, the sorting module 240 may push the read commands having the overage queue counts being 0 into the overage queue. If it is determined that all of the overage queue counts are not 0 in step S584, the sorting module 240 may execute step S590, i.e., to complete one command scheduling.

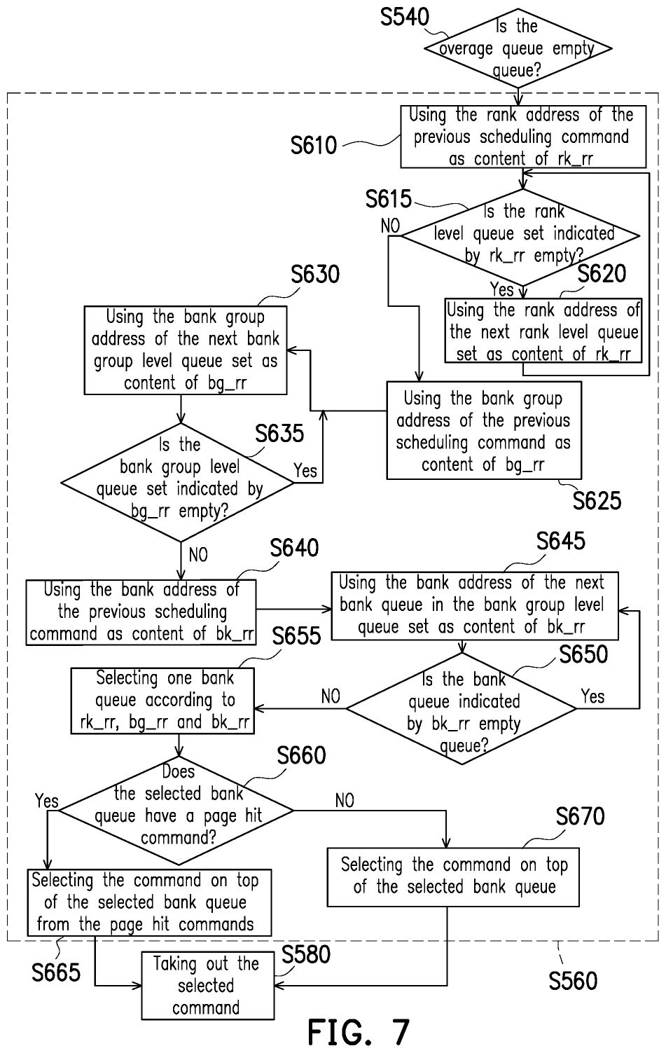

FIG. 7 is a flowchart illustrating the process of step S560 depicted in FIG. 6 according to another embodiment of the embodiment. Step S560 depicted in FIG. 7 includes steps S610 to S670. Step S610 to S620 depicted in FIG. 7 may also be regarded as one of exemplary examples for step S810 depicted in FIG. 2. Step S625 to S650 depicted in FIG. 7 may also be regarded as one of exemplary examples for step S820 depicted in FIG. 2. Step S655 to S670 depicted in FIG. 7 may be regarded as one of exemplary examples for step S830 depicted in FIG. 2.

With reference to FIG. 7, in step S610, the sorting module 240 may select a rank level queue set where “the previous scheduling command” belongs from a plurality of rank level queue sets of the read scheduling queue 230 (the read command queue set) as a selected rank level queue set. In step S615, the sorting module 240 may determine whether the selected rank level queue set is empty. When the selected rank level queue set is empty, the sorting module 240 may select a next rank level queue set from the rank level queue sets as the selected rank level queue set. When the selected rank level queue set is not empty, the sorting module 240 may use the access commands belonging to the selected rank level queue set as the first candidate command.

For instance, the sorting module 240 may use the rank address of “the previous scheduling command” as content of a rank polling variable rk_rr in step S610. In step S615, the sorting module 240 may determine whether the rank level queue set of the read scheduling queue 230 (the read command queue set) indicated by the rank polling variable rk_rr is empty. If a determination result in step S615 is “Yes”, the sorting module 240 may use the rank address of the next rank level queue set in the read scheduling queue 230 (the read command queue set) as content of the rank polling variable rk_rr in step S620.

Next, the sorting module 240 executes step S615 again. If the determination result in step S615 is “No”, the sorting module 240 may execute step S625.

In step S625, the sorting module 240 may select one (first bank group level queue set) from a plurality of bank group level queue sets of the read scheduling queue 230 (the read command queue set) as a selected bank group level queue set. A bank group address of this first bank group level queue set is different from a bank group address of “the previous scheduling command”. When the selected bank group level queue set is empty, the sorting module 240 may select one (second bank group level queue set) from the bank group level queue sets of the read scheduling queue 230 (the read command queue set) as the selected bank group level queue set (step S630 and step S635). Here, a bank group address of the second bank group level queue set is different from the bank group address of “the previous scheduling command”. When the selected bank group level queue set is not empty, the sorting module 240 may select one (first bank queue) from a plurality of bank queues of the read scheduling queue 230 (the read command queue set) as a selected bank queue (step S640). Here, a bank address of the first bank queue is different from a bank address of “the previous scheduling command”. When the selected bank queue is empty, the sorting module 240 may select one (second bank queue) from the bank queues of the read scheduling queue 230 (the read command queue set) as the selected bank queue (step S645 and step S650). Here, a bank address of the second bank queue is different from the bank address of “the previous scheduling command”. When the selected bank queue is not empty, the access commands stored by the selected bank queue (which are the read commands at the time) are used as the second candidate command.

For instance, the sorting module 240 may use the bank group address of “the previous scheduling command” in the rank level queue set indicated by the rank polling variable rk_rr as content of a bank group polling variable bg_rr in step S625. Next, in step S630, the sorting module 240 may use a bank group address of a next bank group level queue set in the rank level queue set indicated by the rank polling variable rk_rr as content of the bank group polling variable bg_rr. In step S635, the sorting module 240 may determine whether the bank group level queue set of the read scheduling queue 230 (the read command queue set) indicated by the bank group polling variable bg_rr is empty. If a determination result in step S635 is “Yes”, the sorting module 240 executes step S630 again. If the determination result in step S635 is “No”, the sorting module 240 executes step S640.

In step S640, the sorting module 240 may use a bank address of “the previous scheduling command” in the bank group level queue set indicated by the bank group polling variable bg_rr as content of a bank polling variable bk_rr. Next, in step S645, the sorting module 240 may use a bank address of a next bank queue in the bank group level queue set indicated by the bank group polling variable bg_rr as content of the bank polling variable bk_rr. In step S650, the sorting module 240 may determine whether the bank queue of the read scheduling queue 230 (the read command queue set) indicated by the bank polling variable bk_rr is empty queue. If a determination result in step S650 is “Yes”, the sorting module 240 executes step S645 again. If the determination result in step S650 is “No”, the sorting module 240 executes step S655.

In step S655, the sorting module 240 may select one bank queue in the read scheduling queue 230 (the read command queue set) as the selected bank queue according to the rank polling variable rk_rr, the bank group polling variable bg_rr and the bank polling variable bk_rr. In step S660, the sorting module 240 may determine whether the selected bank queue has a page hit command. If a determination result in step S660 is “Yes”, the sorting module 240 may select the read command on top of the selected bank queue from the page hit commands of the selected bank queue (step S665). If the determination result in step S660 is “No”, the sorting module 240 may select the command on top of the bank queue from the selected bank queue (step S670). After step S665 or step S670 is completed, the sorting module 240 may perform step S580 depicted in FIG. 6.

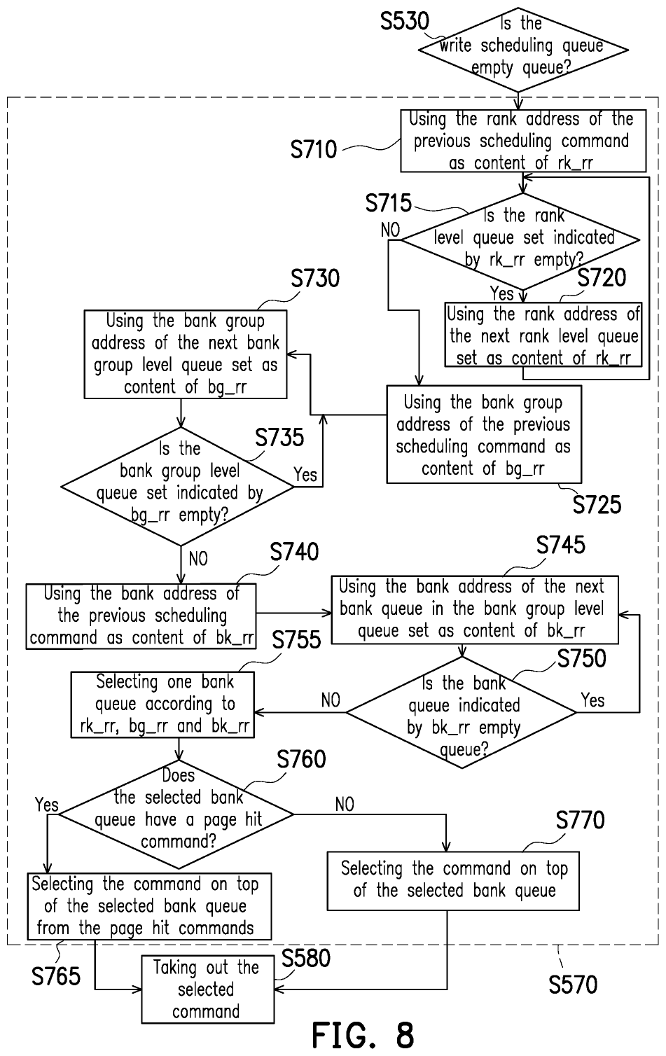

FIG. 8 is a flowchart illustrating the process of step S570 depicted in FIG. 6 according to another embodiment of the invention. Step S570 depicted in FIG. 8 includes steps S710 to S770. Step S710 to S720 in FIG. 8 may be also regarded as one of exemplary examples for step S810 depicted in FIG. 2. Step S725 to S750 depicted in FIG. 8 may also be regarded as one of exemplary examples for step S820 depicted in FIG. 2. Step S755 to S770 depicted in FIG. 8 may be regarded as one of exemplary examples for step S830 depicted in FIG. 2.

With reference to FIG. 8, in step S710, the sorting module 240 may select a rank level queue set where “the previous scheduling command” belongs from a plurality of rank level queue sets of the write scheduling queue 220 (the write command queue set) as a selected rank level queue set. In step S715, the sorting module 240 may determine whether the selected rank level queue set is empty. When the selected rank level queue set is empty, the sorting module 240 may select a next rank level queue set from the rank level queue sets as the selected rank level queue set. When the selected rank level queue set is not empty, the sorting module 240 may use the access commands belonging to the selected rank level queue set as the first candidate command.

For instance, the sorting module 240 may use the rank address of “the previous scheduling command” as content of a rank polling variable rk_rr in step S710. In step S715, the sorting module 240 may determine whether the rank level queue set of the write scheduling queue 220 (the write command queue set) indicated by the rank polling variable rk_rr is empty. If a determination result in step S715 is “Yes”, the sorting module 240 may use the rank address of the next rank level queue set in the write scheduling queue 220 (the write command queue set) as content of the rank polling variable rk_rr in step S720. Next, the sorting module 240 executes step S715 again. If the determination result in step S715 is “No”, the sorting module 240 may execute step S725.

In step S725, the sorting module 240 may select one (first bank group level queue set) from a plurality of bank group level queue sets of the write scheduling queue 220 (the write command queue set) as a selected bank group level queue set. A bank group address of this first bank group level queue set is different from a bank group address of “the previous scheduling command”. When the selected bank group level queue set is empty, the sorting module 240 may select one (second bank group level queue set) from the bank group level queue sets of the write scheduling queue 220 (the write command queue set) as the selected bank group level queue set (step S730 and step S735). Here, a bank group address of the second bank group level queue set is different from the bank group address of “the previous scheduling command”. When the selected bank group level queue set is not empty, the sorting module 240 may select one (first bank queue) from a plurality of bank queues of the write scheduling queue 220 (the write command queue set) as a selected bank queue (step S740). Here, a bank address of the first bank queue is different from a bank address of “the previous scheduling command”. When the bank queue is empty, the sorting module 240 may select one (second bank queue) from the bank queues of the write scheduling queue 220 (the write command queue set) as the selected bank queue (step S745 and step S750). Here, a bank address of the second bank queue is different from the bank address of “the previous scheduling command”. When the selected bank queue is not empty, the access commands stored by the selected bank queue (which are the read commands at the time) are used as the second candidate command.

For instance, the sorting module 240 may use the bank group address of “the previous scheduling command” in the rank level queue set indicated by the rank polling variable rk_rr as content of a bank group polling variable bg_rr in step S725. Next, in step S730, the sorting module 240 may use a bank group address of a next bank group level queue set in the rank level queue set indicated by the rank polling variable rk_rr as content of the bank group polling variable bg_rr. In step S735, the sorting module 240 may determine whether the bank group level queue set of the write scheduling queue 220 (the write command queue set) indicated by the bank group polling variable bg_rr is empty. If a determination result in step S735 is “Yes”, the sorting module 240 executes step S730 again. If the determination result in step S735 is “No”, the sorting module 240 executes step S740.

In step S740, the sorting module 240 may use a bank address of “the previous scheduling command” in the bank group level queue set indicated by the bank group polling variable bg_rr as content of a bank polling variable bk_rr. Next, in step S745, the sorting module 240 may use a bank address of a next bank queue in the bank group level queue set indicated by the bank group polling variable bg_rr as content of the bank polling variable bk_rr. In step S750, the sorting module 240 may determine whether the bank queue of the write scheduling queue 220 (the write command queue set) indicated by the bank polling variable bk_rr is empty queue. If a determination result in step S750 is “Yes”, the sorting module 240 executes step S745 again. If the determination result in step S750 is “No”, the sorting module 240 executes step S755.

In step S755, the sorting module 240 may select one bank queue in the write scheduling queue 220 (the write command queue set) as the selected bank queue according to the rank polling variable rk_rr, the bank group polling variable bg_rr and the bank polling variable bk_rr. In step S760, the sorting module 240 may determine whether the selected bank queue has a page hit command. If a determination result in step S760 is “Yes”, the sorting module 240 may select the write command on top of the selected bank queue from the page hit commands of the selected bank queue (step S765). If the determination result in step S760 is “No”, the sorting module 240 select the command on top of the bank queue from the selected bank queue (step S770). After step S765 or step S770 is completed, the sorting module 240 may perform step S580 depicted in FIG. 6.

In view of the above, the sorting module 240 uses the rank polling variable rk_rr, the bank group polling variable bg_rr and the bank polling variable bk_rr to perform the command reordering. Among them, the bank group polling variable bg_rr adopts a polling mechanism between the different bank group level queue sets in the same rank so the bank group address of the current scheduling command is different from the bank group address of the previous scheduling command. The bank polling variable bk_rr adopts a polling mechanism between the different bank queues in the same bank group so the bank address of the current scheduling command is different from the bank address of the previous scheduling command. The rank polling variable rk_rr may allow the rank address of the current scheduling command to be identical to the rank address of the previous scheduling command.

In addition, in conjunction with FIG. 6, FIG. 7 and FIG. 8, when the consecutive access commands all have the same bank address, a scheduling priority order is to: preferentially select the read command sorted on top of the overage queue, then select the command on top of the selected bank queue from the page hit commands in the selected bank queue, and select the command on top of the bank queue from the selected bank queue (i.e., a page miss command). In other words, when there are multiple access commands belonging to the same bank queue, the read command that waited for a long time without being selected is preferentially select first, then the page hit command is selected, and lastly, the page miss command is selected. By taking the priority order described above, the problem regarding the overly long waiting time may be solved for the read command.

In summary, the memory apparatus and the command reordering method of the invention can optimize memory bandwidth performance and reorder the commands based on levels of the rank level and bank level so as to reduce the probability of page conflict in the banks and effectively improve memory bandwidth utilization.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A memory apparatus, comprising:
at least one memory, and
a controller, coupled to the memory and the controller is configured to provide a plurality of access commands and perform a command reordering method for the access commands, wherein the command reordering method comprises:
a rank level step, selecting at least one command with a rank address of a previous scheduling command from the access commands as at least one first candidate command;
a bank level step, selecting at least one command with a different bank address compared to the previous scheduling command from the at least one first candidate command as at least one second candidate command; and
selecting one command from the at least one second candidate command as a current scheduling command.

2. The memory apparatus of claim 1, wherein the rank level step comprises:
when the at least one command with the rank address of the previous scheduling command does not exist in the access commands, selecting at least one command with a next rank address from the access commands as the at least one first candidate command, wherein the next rank address is different from the rank address of the previous scheduling command.

3. The memory apparatus of claim 1, wherein the rank level step comprises:
selecting a rank level queue set where the previous scheduling command belongs to from a plurality of rank level queue sets as a selected rank level queue set;
when the selected rank level queue set is empty, selecting a next rank level queue set from the rank level queue sets as the selected rank level queue set; and
when the selected rank level queue set is not empty, using the access commands belonging to the selected rank level queue set as the at least one first candidate command.

4. The memory apparatus of claim 1, wherein the bank level step comprises:
selecting a first bank group level queue set from a plurality of bank group level queue sets as a selected bank group level queue set, wherein a bank group address of the first bank group level queue set is different from a bank group address of the previous scheduling command;
when the selected bank group level queue set is empty, selecting a second bank group level queue set from the bank group level queue sets as the selected bank group level queue set;
when the selected bank group level queue set is not empty, selecting a first bank queue from a plurality of bank queues as a selected bank queue, wherein a bank address of the first bank queue is different from a bank address of the previous scheduling command;
when the selected bank queue is empty, selecting a second bank queue from the bank queues as the selected bank queue; and
when the selected bank queue is not empty, using the access commands belonging to the selected bank queue as the at least one second candidate command.

5. The memory apparatus of claim 4, wherein a bank group address of the second bank group level queue set is different from the bank group address of the previous scheduling command, and a bank address of the second bank queue is different from the bank address of the previous scheduling command.

6. The memory apparatus of claim 1, wherein the command reordering method further comprises:
determining whether a current time is in a read scheduling window or a write scheduling window;
when the current time is in the read scheduling window, obtaining a first checking result by checking whether a read command queue set is empty, and determining whether to enter the write scheduling window by ending the read scheduling window according to the first checking result; and
when the current time is in the write scheduling window, obtaining a second checking result by checking whether a write command queue set is empty, and determining whether to enter the read scheduling window by ending the write scheduling window according to the second checking result.

7. The memory apparatus of claim 6, wherein the access commands comprise a plurality of read commands, and the command reordering method further comprises:
when the current time is in the read scheduling window, checking whether an overage queue is empty;
when the current time is in the read scheduling window and the overage queue is not empty, scheduling one read command from the overage queue as the current scheduling command; and
when the current time is in the read scheduling window and the overage queue is empty, performing the rank level step and the bank level step to select the at least one second candidate command from the read commands.

8. The memory apparatus of claim 6, wherein the access commands comprise a plurality of write commands, and the command reordering method further comprises:
when the current time is in the write scheduling window, performing the rank level step and the bank level step to select the at least one second candidate command from the write commands.

9. The memory apparatus of claim 1, wherein the step of selecting one command from the at least one second candidate command as the current scheduling command further comprises:
when the at least one second candidate command includes at least one page hit command, selecting one of the at least one page hit command as the current scheduling command; and
when the at least one second candidate command does not include the page hit command, selecting one of the at least one second candidate command as the current scheduling command.

10. A command reordering method, adapted to a memory apparatus, the memory apparatus comprising at least one memory and a controller, wherein the command reordering method comprises:
a rank level step, selecting at least one command having a rank address of a previous scheduling command from a plurality of access commands provided by the controller as at least one first candidate command;
a bank level step, selecting at least one command having a different bank address compared to the previous scheduling command from the at least one first candidate command as at least one second candidate command; and
selecting one command from the at least one second candidate command as a current scheduling command.

11. The command reordering method of claim 10, wherein the rank level step comprises:
when the at least one command having the rank address of the previous scheduling command does not exist in the access commands, selecting at least one command having a next rank address from the access commands as the at least one first candidate command, wherein the next rank address is different from the rank address of the previous scheduling command.

12. The command reordering method of claim 10, wherein the rank level step comprises:
selecting a rank level queue set where the previous scheduling command belongs from a plurality of rank level queue sets as a selected rank level queue set;
when the selected rank level queue set is empty, selecting a next rank level queue set from the rank level queue sets as the selected rank level queue set; and
when the selected rank level queue set is not empty, using the access commands belonging to the selected rank level queue set as the at least one first candidate command.

13. The command reordering method of claim 10, wherein the bank level step comprises:
selecting a first bank group level queue set from a plurality of bank group level queue sets as a selected bank group level queue set, wherein a bank group address of the first bank group level queue set is different from a bank group address of the previous scheduling command;
when the selected bank group level queue set is empty, selecting a second bank group level queue set from the bank group level queue sets as the selected bank group level queue set;
when the selected bank group level queue set is not empty, selecting a first bank queue from a plurality of bank queues as a selected bank queue, wherein a bank address of the first bank queue is different from a bank address of the previous scheduling command;
when the selected bank queue is empty, selecting a second bank queue from the bank queues as the selected bank queue; and
when the selected bank queue is not empty, using the access commands belonging to the selected bank queue as the at least one second candidate command.

14. The command reordering method of claim 13, wherein a bank group address of the second bank group level queue set is different from the bank group address of the previous scheduling command, and a bank address of the second bank queue is different from the bank address of the previous scheduling command.

15. The command reordering method of claim 10, further comprising:
determining whether a current time is in a read scheduling window or a write scheduling window;
when the current time is in the read scheduling window, obtaining a first checking result by checking whether a read command queue set is empty, and determining whether to enter the write scheduling window by ending the read scheduling window according to the first checking result; and
when the current time is in the write scheduling window, obtaining a second checking result by checking whether a write command queue set is empty, and determining whether to enter the read scheduling window by ending the write scheduling window according to the second checking result.

16. The command reordering method of claim 15, wherein the access commands comprise a plurality of read commands, and the command reordering method further comprises:
when the current time is in the read scheduling window, checking whether an overage queue is empty;
when the current time is in the read scheduling window and the overage queue is not empty, scheduling one read command from the overage queue as the current scheduling command; and
when the current time is in the read scheduling window and the overage queue is empty, performing the rank level step and the bank level step to select the at least one second candidate command from the read commands.

17. The command reordering method of claim 15, wherein the access commands comprise a plurality of write commands, and the command reordering method further comprises:
when the current time is in the write scheduling window, performing the rank level step and the bank level step to select the at least one second candidate command from the write commands.

18. The command reordering method of claim 10, wherein the step of selecting one command from the at least one second candidate command as the current scheduling command further comprises:
when the at least one second candidate command includes at least one page hit command, selecting one of the at least one page hit command as the current scheduling command; and
when the at least one second candidate command does not include the page hit command, selecting one of the at least one second candidate command as the current scheduling command.
